(19) United States
(12) Patent Application Publication
(10) Pub. No.: US 2004/0149593 A1
(43) Pub. Date: Aug. 5, 2004

(54) Electro-chemical cleaning process for electrical connectors

(76) Inventor: Erik Orwoll, Phoenix, AZ (US)

Correspondence Address: WEISS & MOY PC, 4204 NORTH BROWN AVENUE, SCOTTSDALE, AZ, 85251, US

(21) Appl. No.: 10/382,751

(22) Filed: Mar. 5, 2003

Related U.S. Application Data
(60) Provisional application No. 60/361,883, filed on Mar. 5, 2002.

(51) Int. Cl. B23H 3/00

(52) U.S. Cl. 205/710

(57) ABSTRACT

A method for removing solder and other debris from electrical contacts comprising: coupling a positive lead of a power source to the electrical contacts to be cleaned; coupling a negative lead of the power source to a collection plate; placing the electrical contacts and the collection plate in a electrolyte solution; and applying a bias voltage from the power supply to the leads causing the solder and other debris from the electrical contacts to be removed.

### RELATED APPLICATIONS

This patent application is claiming the benefit of the U.S. Provisional Application having an application number of 60/361,883, filed Mar. 5, 2002, in the name of Erik Orwoll, and entitled “ELECTRO-CHEMICAL CLEANING PROCESS FOR ELECTRICAL CONNECTIONS”.

### BACKGROUND OF THE INVENTION

1. Field of the Invention

This invention relates to electrical connectors, and, more specifically, to an electrochemical cleaning process which will remove solder and other debris from the electrical connectors in a reliable and cost effective manner in order to restore the electrical connectors to a usable state.

2. Description of the Prior Art

In semiconductor manufacturing, integrated circuits (IC's) are packaged in several different formats which allow them to be soldered to a circuit board. These packaging types include: BGA, QFP, QFN, CSP, and many other styles.

The testing of the IC's is a very important step in the production of quality semiconductor devices. A number of different tests may be performed on the integrated circuit to identify whether the circuit is operating correctly and whether or not the circuit is likely to malfunction in the future. The packages (chips) are tested both during and after the manufacturing process to verify functionality. The testing occurs by contacting the leads (IO's) of the device with electrical contacts where test signals can be passed through the device. This process typically utilizes wafer probes to contact the bare die, and utilizes test connectors to test die that is in its final packaged form. Burn-In and HAST testing often occurs in conjunction with the other tests to determine infant mortality rates and endurance levels. Programmable devices are subjected to additional interface with electrical connectors during the final “programming” production phase. These programming connectors are subject to the same solder contamination and failure issues.

Each time a test occurs, the leads of the device are mechanically contacted with an electrical test device to establish an electrical path. As this mechanical contact is made, small amounts of solder are transferred to the contact point of the electrical tester. As this process is repeated, solder continues to be transferred to the contact point. Each layer of transferred solder will oxidize, which increases the electrical resistance of the connection. Eventually, the resistance becomes so high that the degraded electrical signal prevents the device from being tested properly.

When this failure occurs, the tester must be taken out of service. The tester is then repaired, replaced, or cleaned. Repair and replacement is costly, and the current cleaning methods can be costly, ineffective, and unreliable. Connectors which are soldered to the circuit board often cannot be replaced without damaging the circuit board.

It should also be noted that the transfer of solder to the mechanical point of, contact can be accelerated at high temperatures. Solder oxidation also occurs at a higher rate. Therefore, connectors used at high temperature (such as Burn-In) may fail sooner than those used at ambient temperature.

Current cleaning methods include: chemical, abrasive, mechanical, and ultra-sonic. While each of these different processes offer some benefits, there are different disadvantages associated with each of them. For example, chemical cleaning utilizes harsh chemicals that can be harmful to the connector, and are often toxic. Abrasive cleaning can damage the contact by removing the under-plating which is typically gold. Mechanical cleaning utilizes brushes (typically brass) in order to scrub the contact points. This is inconsistent, can cause damage to the contact, and physical geometry can block access to the contact area (which prevents the brush method from being an option). Ultra-sonic cleaning removes dirt and loose particles, but has little or no effect on transferred solder.

Therefore, a need existed to provide a reliable, cost effective process to remove solder from electrical contacts to restore electrical connectors to a usable state.

### SUMMARY OF THE INVENTION

In accordance with one embodiment of the present invention, it is an object of the present invention to provide an improved cleaning process for electrical connectors/contacts.

It is another object of the present invention to provide a reliable, cost effective process to remove solder contamination from electrical contacts to restore electrical connectors to a usable state.

### BRIEF DESCRIPTION OF THE EMBODIMENTS

In accordance with one embodiment of the present invention, a method for removing solder and other debris from electrical contacts is disclosed. The method comprises: coupling a positive lead of a power source to the electrical contacts to be cleaned; coupling a negative lead of the power source to a collection plate; placing the electrical contacts and the collection plate in a electrolyte solution; and applying a bias voltage from the power supply to the leads causing the solder and other debris from the electrical contacts to be removed.

In accordance with another embodiment of the present invention, a method for removing solder and other debris from electrical contacts is disclosed. The method comprising: coupling a positive lead of a power source to the electrical contacts to be cleaned; coupling a negative lead of the power source to a collection plate; coupling a current meter in series with the with the power supply; placing the electrical contacts and the collection plate in a electrolyte solution; circulating the electrolyte solution; applying a bias voltage from the power supply to the leads causing the solder and other debris from the electrical contacts; monitoring the current meter until a current level is approximately zero; and turning off the power supply when the current level is approximately zero.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The invention itself, as well as a preferred mode of use, and advantages thereof, will best be understood by reference to the following detailed description of illustrated embodiment when read in conjunction with the accompanying drawings, wherein like reference numerals and symbols represent like elements.

FIG. 1 depicts typical resin and solder build up on an electrical connector.

FIG. 2 depicts a simplified block diagram of the cleaning process of the present invention.

FIG. 3 is a simplified functional block diagram of the electroplating set-up.

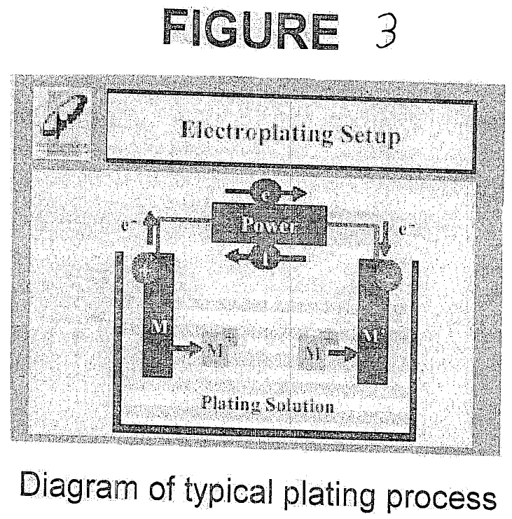

### DETAILED DESCRIPTION OF THE PREFERRED EMBODIMENT

The present invention consists of a process which electrochemically removes solder and other debris from electrical contacts. The method may be used to clean any type of electrical connectors/sockets. The method may be used to clean test connectors/sockets, burn-in connectors/sockets, production connectors/sockets, wafer probes and the like. It should be noted that the listing of the different types of connectors should not be seen as to limit the scope of the present invention. The electro-chemical cleaning process may be used to clean any type of electrical connector/socket.

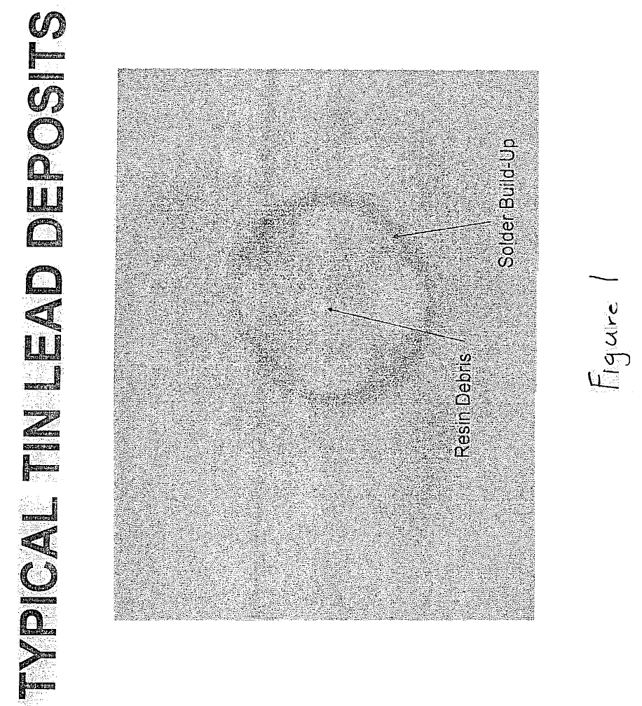

Referring to FIG. 1, as stated above, testing occurs by contacting the leads (10's) of the device with electrical contacts where test signals can be passed through the device. This process typically utilizes wafer probes to contact the bare die or bumped die, and utilizes test connectors to test die that is in its final packaged form. Burn-In and HAST testing often occurs in conjunction with the other tests to determine infant mortality rates and endurance levels.

Each time a test occurs, the leads of the device are mechanically contacted with an electrical test device to establish an electrical path. As this mechanical contact is made, small amounts of solder are transferred to the contact point of the electrical tester as shown in FIG. 1. As this process is repeated, solder continues to be transferred to the contact point. Each layer of transferred solder will oxidize, which increases the electrical resistance of the connection. Eventually, the resistance becomes so high that the degraded electrical signal prevents the device from being tested properly.

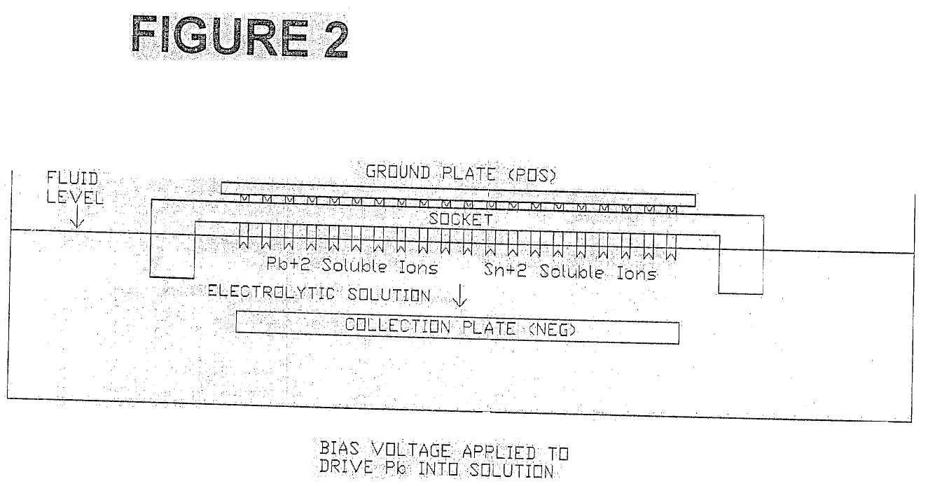

Referring now to FIG. 2, a reliable, cost effective electrochemical process to remove solder from electrical contacts to restore electrical connectors to a usable state will be described. In general, an electrolyte solution is provided. A small pump is used to circulate the solution. A power source is adjusted to provide an appropriate output voltage. The positive lead of the power source is connected to all of the contacts of the connector. In general, some type of conductive plate is used which will be in contact with each lead. The negative lead is attached to the collection plate. Both connections are made with the use of connectors such as alligator clips. The process is initiated by applying a bias voltage from a power supply. A current meter is placed in series to monitor the current flow. During the cleaning process the current will decrease till the final current reaches approximately zero. The power supply is turned off. The majority of the solder should now have been removed, and only a small amount of material remained on the contacts.

The leads may then be reversed to apply a reverse polarity. The above process may be reinitiated with the voltage applied for approximately 1 minute. This process may continue until nearly all of the solder is removed from the contacts.

### EXAMPLE 1

The cleaning process is applied to the leads of a BGA connector to see the results. The socket had been cycled 10,000 times and had also been through multiple heat cycles in excess of 125 C. The contacts had noticeable transfer of solder at the area where contact is mated to the BGA device. The socket was fixtured per FIG. 2.

In general, an electrolyte solution is provided. In this embodiment, the solution is approximately 0.50 molar Ammonium Acetate, approximately 0.06 molar Lead (II) Acetate, and approximately 0.06 molar Tin Fluoride is used as the electrolyte. A small pump circulates the fluid to keep the Tin Fluoride in solution. A dc power source is adjusted to provide an output of approximately 0.33 volts. The positive lead of the dc power source is connected to all of the contacts of the connector by using a stainless steel fiber pad which was compressed against the ends of the contact leads. The negative lead was attached to the stainless steel collection plate. Both connections were made with the use of alligator clips. However, other types of connectors may be used. The process is initiated by applying a bias voltage from a power supply. A dc current meter was placed in series to monitor the current flow. The process took approximately 8 minutes. During the cleaning process the initial current was 1.12 milliamps and the final current was 0.006 milliamps (nearly zero). The power supply was turned off. The contacts were examined under a microscope. The majority of the solder had been removed, and only a small amount of material remained on the contacts. The material remaining was somewhat dark in color.

The leads were then reversed to apply a reverse polarity and the process was reinitiated with the voltage applied for 1 minute. The leads were disconnected and returned to the original polarity. The voltage was applied for a period of 4 minutes until the current dropped to 0.005 milliamps. The contacts were examined under a microscope. Nearly all of the solder had been removed from the contacts. Very minute dark areas remained on the contacts.

### EXAMPLE 2

The same setup was used, except the socket was replaced with a bare strand of 60/40 solder (60% Tin/40% Lead).

The positive lead was attached to the solder, and the negative lead to the collection plate. The power supply was turned on and the initial current flow was 9.5 milliamps. After a period of 4 minutes, the current dropped to 6.7 milliamps and the collection plate became dark with build-up. The power supply was disconnected.

### EXAMPLE 3

Same setup as Example 2, but the solder used was Lead free 96/4 (96% Tin/4% Silver). Initial current was 0.35 milliamps. After a period of 30 minutes, the current dropped to 0.17 milliamps. After 35 minutes, the build-up on the collection plate shorted across to the solder, and the current spiked. The power was immediately disconnected.

As shown in Example 3 the process will be useful after the electronics industry converts to lead free solder.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for removing solder and other debris from electrical contacts comprising:
coupling a positive lead of a power source to the electrical contacts to be cleaned;
coupling a negative lead of the power source to a collection plate;
placing the electrical contacts and the collection plate in a electrolyte solution; and
applying a bias voltage from the power supply to the leads causing the solder and other debris from the electrical contacts to be removed.

2. The method of claim 1 further comprising circulating the electrolyte solution.

3. The method of claim 1 further comprising:
coupling a current meter in series with the with the power supply; and
monitoring the current meter until a current level is approximately zero; and
turning off the power supply when the current level is approximately zero.

4. The method of claim 1 further comprising applying a reverse polarity.

5. The method of claim 4 wherein applying a reverse polarity comprises:
removing the positive lead from the electrical contacts;
removing the negative lead from the collection plate;
coupling the positive lead to the collection plate; and
coupling the negative lead to the electrical contacts.

6. The method of claim 1 further comprising providing an electrolyte solution of approximately 0.50 molar ammonium acetate, approximately 0.06 molar lead acetate, and approximately 0.6 molar tin fluoride.

7. The method of claim 1 further comprising applying a voltage of approximately 0.33 volts from the power source to the electrical contacts.

8. The method of claim 1 further comprising coupling the positive lead of the power supply to the electrical contacts by using a stainless steel fiber pad.

9. The method of claim 1 wherein the power supply is a DC power supply.

10. A method for removing solder and other debris from electrical contacts comprising:
coupling a positive lead of a power source to the electrical contacts to be cleaned;
coupling a negative lead of the power source to a collection plate;
coupling a current meter in series with the with the power supply;
placing the electrical contacts and the collection plate in a electrolyte solution;
circulating the electrolyte solution;
applying a bias voltage from the power supply to the leads causing the solder and other debris from the electrical contacts;
monitoring the current meter until a current level is approximately zero; and
turning off the power supply when the current level is approximately zero.

11. The method of claim 10 further comprising applying a reverse polarity.

12. The method of claim 11 wherein applying a reverse polarity comprises:
removing the positive lead from the electrical contacts;
removing the negative lead from the collection plate;
coupling the positive lead to the collection plate; and
coupling the negative lead to the electrical contacts.

13. The method of claim 10 further comprising providing an electrolyte solution of approximately 0.50 molar ammonium acetate, approximately 0.06 molar lead acetate, and approximately 0.6 molar tin fluoride.

14. The method of claim 10 further comprising applying a voltage of approximately 0.33 volts from the power source to the electrical contacts.

15. The method of claim 1 further comprising coupling the positive lead of the power supply to the electrical contacts by using a stainless steel fiber pad.

16. The method of claim 10 wherein the power supply is a DC power supply.
